(19) United States
(12) Patent Application Publication
(10) Pub. No.: US 2013/0222287 A1
(43) Pub. Date: Aug. 29, 2013

(54) APPARATUS AND METHOD FOR IDENTIFYING A VALID INPUT SIGNAL IN A TERMINAL

(71) Applicant: Pantech Co., Ltd., (US)

(72) Inventors: Ki Tae BAE, Seoul (KR); Young Rak Park, Seoul (KR)

(73) Assignee: Pantech Co., Ltd., Seoul (KR)

(21) Appl. No.: 13/711,995

(22) Filed: Dec. 12, 2012

(30) Foreign Application Priority Data
Feb. 29, 2012 (KR) 10-2012-0021476

(51) Int. Cl. G06F 3/041

(52) U.S. Cl. CPC G06F 3/041
USPC 345/173

(57) ABSTRACT

A portable terminal includes a touch input unit to determine whether a first touch is detected in a display area or a grip recognition area, a determining unit to determine validity of the first touch based on a location of the detected first touch, and a processing unit to perform an event corresponding to the first touch when the first touch is determined to be valid. A method for validating a first touch using a processor includes detecting the first touch on a display area or a grip recognition area of a terminal, determining validity of the first touch based on a location of the detected first touch, and performing, using the processor, an event corresponding to the first touch if the first touch is determined to be valid.

### CROSS-REFERENCE TO RELATED APPLICATION

This application claims priority from and the benefit under 35 U.S.C. §119(a) of a Korean Patent Application No. 10-2012-0021476, filed on Feb. 29, 2012, which is hereby incorporated by reference for all purposes as if fully set forth herein.

### BACKGROUND

1. Field

Exemplary embodiments of the present invention relate to an apparatus and a method for identifying a valid input signal in a terminal.

2. Discussion of the Background

FIG. 1 is a diagram illustrating an operation of processing an input of a touch according to the related art.

When an input of a touch is sensed by a touch sensor, a touch sensor driver may sense or detect that the touch is inputted on a display area of the terminal, may extract coordinates of the touch, and may transfer the extracted coordinates to a touch event dispatcher. The touch event dispatcher may process the coordinates to be usable in an application and may transfer the processed coordinates to the application. The application may perform a corresponding operation based on the transferred coordinates, and/or configure a screen of the terminal to respond to the inputted touch.

When an input of a touch is sensed by the touch sensor, an input device recognizing unit of the terminal may detect the input of the touch in a display area of the terminal, may determine and extract a central point or region of a touched area or the touch, and may transfer a coordinate value of the central point or region to an event processing unit. The event processing unit may perform an appropriate action or operation based on the coordinate value of the inputted touch.

In the related art, when a user grips a terminal with a bezel, a frame, or a casing of a reference width, fingers, palms, or other parts of a user's body may contact with the bezel without touching the display area of the terminal. More specifically, because the user may grip the terminal by the bezel without touching the display area, which may be used to detect or receive a touch as an input, the terminal may not receive a touch input by gripping the terminal by the bezel. However, when the user grips a terminal with a thin or no bezel or a terminal with a thin frame, fingers, palms, or other parts of the user's body may unintentionally contact a display screen when the user grips or holds the terminal. In an example, the terminal with a little or no bezel area or a thin frame may be referred to as a thin-bezel terminal, but is not limited thereto. Accordingly, an unintended touch may be inputted by the user gripping or holding the thin-bezel terminal. More specifically, because the touch unintended by a user may be recognized and be processed by the terminal, a malfunction or unintended response from the terminal with a touch screen may occur.

In the related art, a touch may be unconditionally recognized or detected upon input. Therefore, regardless of a user's intent, when a touch input is detected, a terminal may execute an action corresponding to the touch. The above method may not distinguish between an unintended touch that may occur due to gripping or holding of the thin-bezel terminal and an actual intended touch inputted by the user. Accordingly, unintended responses may be provided by the thin-bezel terminal, which may trigger some inconvenience in use.

### SUMMARY

Exemplary embodiments of the present invention provide an apparatus and a method for identifying a valid input signal in a terminal.

Additional features of the invention will be set forth in the description which follows, and in part will be apparent from the description, or may be learned by practice of the invention.

Exemplary embodiments of the present invention provide a portable terminal including a touch input unit to determine whether a first touch is detected in a display area or a grip recognition area; a determining unit to determine validity of the first touch based on a location of the detected first touch; and a processing unit to perform an event corresponding to the first touch when the first touch is determined to be valid.

Exemplary embodiments of the present invention provide a method for validating a first touch using a processor including detecting the first touch on a display area or a grip recognition area of a terminal; determining validity of the first touch based on a location of the detected first touch; and performing, using the processor, an event corresponding to the first touch if the first touch is determined to be valid.

Exemplary embodiments of the present invention provide a non-transitory computer-readable medium comprising a program, executable by a computer, to perform a method for validating a touch using a processor, the method including detecting the first touch on a display area or a grip recognition area of a terminal; determining validity of the first touch based on a location of the detected first touch; and performing, using the processor, an event corresponding to the first touch if the first touch is determined to be valid.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an operation of processing an input of a touch in a conventional terminal.

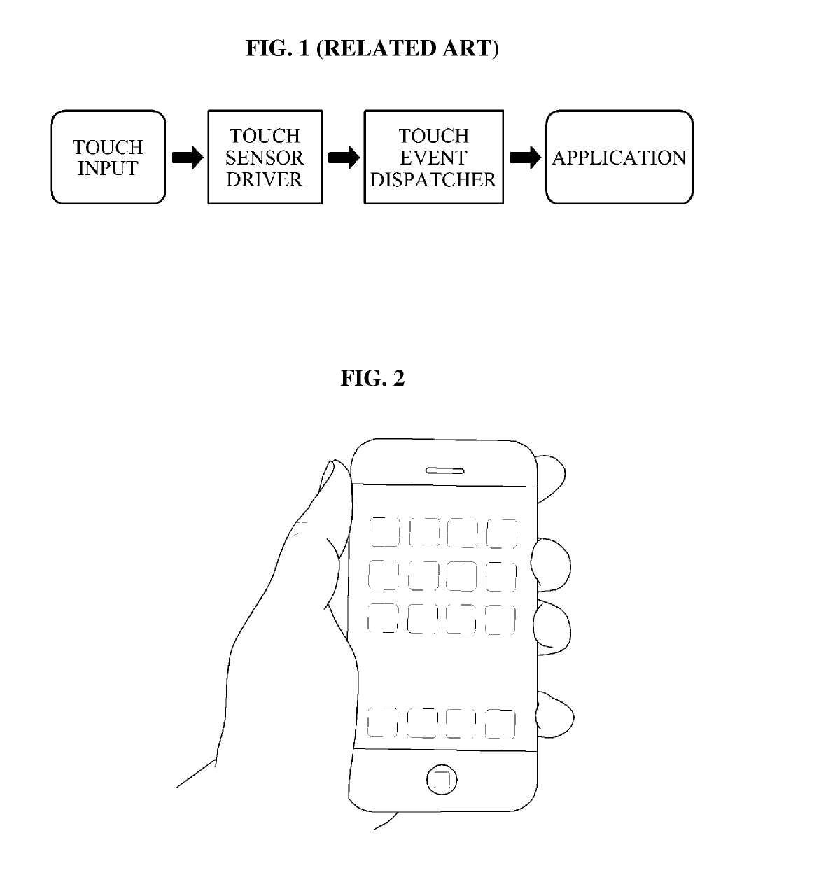

FIG. 2 and FIG. 3 are views illustrating a situation in which a grip is erroneously recognized as a touch in a thin-bezel terminal according to exemplary embodiments of the present invention.

FIG. 4 and FIG. 5 are block diagrams illustrating a process of processing a touch event according to exemplary embodiments of the present invention.

FIG. 6 is a block diagram illustrating a configuration of a touch event decision module according to an exemplary embodiment of the present invention.

FIG. 7 is a flowchart illustrating a method for determining validity of a touch according to an exemplary embodiment of the present invention.

FIG. 8 illustrates a method for extracting a touch detected within an affect range of a grip recognition area according to an exemplary embodiment of the present invention.

FIG. 9 illustrates a method for extracting a consecutively occurring touch detected in a grip recognition area and invalidating the extracted touch according to an exemplary embodiment of the present invention.

FIG. 10 illustrates a method for determining validity of a touch based on an azimuth measured from a gyro sensor according to an exemplary embodiment of the present invention.

FIG. 11 illustrates a circular detection method for determining validity of a touch based on a shape of the touch according to an exemplary embodiment of the present invention.

FIG. 12 illustrates a method for considering a point in time when a touch occurs in a display area and when a touch occurs in a grip recognition area according to an exemplary embodiment of the present invention.

FIG. 13 illustrates a method for determining validity of a first touch by detecting whether a second touch has been received after the first touch is determined to be a touch by grip according to an exemplary embodiment of the present invention.

FIG. 14 is a view illustrating a method for setting a grip recognition area that affects a display area according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that when an element is referred to as being “connected to” another element, it can be directly connected to the other element, or intervening elements may be present. Further, it will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

A conventional thin-bezel terminal may not distinguish between an unintended touch that may be detected due to gripping or holding of the thin-bezel terminal, or an actual intended touch inputted on a display screen of the thin-bezel terminal. Therefore, unintended operations may occur in response to a detection of an unintended touch input, which may provide for some user inconvenience. Exemplary embodiments of the present invention may overcome some inconveniences that may be found in the conventional art by applying some of the following technical configurations.

Before a terminal processes a detected touch, a determining unit may determine a validity of the touch based on a criterion as proposed below and may discard or ignore the detected touch if the detected touch is determined to be associated with gripping or holding of the terminal, which may be determined to be an unintended touch. Accordingly, the terminal may distinguish or filter an intended touch from the unintended touch and transfer the intended touch to a touch event processing unit for further processing. However, aspects of the invention are not limited thereto, such that the terminal may invalidate other touch inputs that may be determined to be an unintended touch. For example, if the user accidentally touches the display screen with a user's palm, the touch made by the user's palm may be determined to be invalid due size of the touch.

To classify types of touches detected in a terminal, exemplary embodiments of the present invention illustrate, without limitation, at least six methods that may be applied to a terminal. A touch detection method may include at least one of a method for extracting a touch detected within a predetermined distance from a grip recognition area, a method for extracting an area connected to the grip recognition area, a method for using a gyro sensor, a circular detection method, a time detection method, and a method for detecting double touches. Prior to describing the methods proposed to classify types of touches, a touch area in a thin-bezel terminal and a process of processing a touch event will be described.

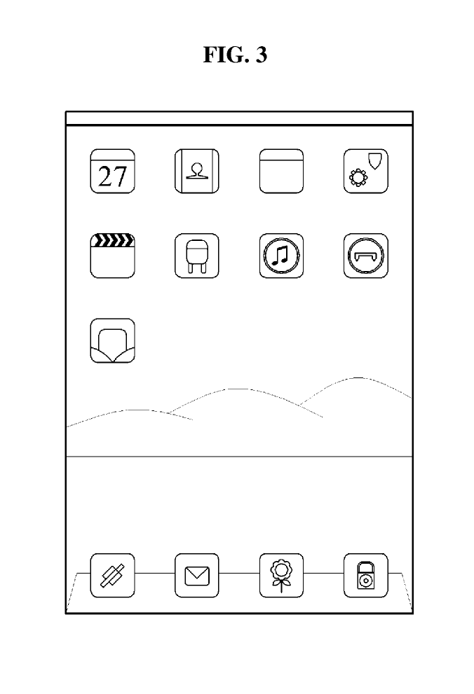

FIG. 2 and FIG. 3 are views illustrating a grip recognition area according to exemplary embodiments of the present invention.

Exemplary embodiments of the present invention relates to a technology capable of preventing or reducing a likelihood of malfunction that may occur in the thin-bezel terminal. To implement exemplary embodiments of the present invention, a touch area limited to a display area in the related art may be extended. The touch area may refer to an area of the display area where a touch input may be detected along with other areas of the display screen, on which image may not be displayed (i.e., surrounding area). Further, the touch area may be larger than the display area, smaller than the display area, or the same size as the display area.

For example, the touch area may be extended further towards a bezel side or an edge of the terminal in the thin-bezel terminal as shown in FIG. 2. The touch area may also be extended to a portion of the terminal where an end of a display is bent or extended to cover up to the entire surface of the thin-bezel terminal as shown in FIG. 3. More specifically, the touch area may be extended to the edges of the horizontal and/or vertical surfaces of the display area or its surrounding area on the display screen. Further, the touch area may include both the display area and the grip recognition area.

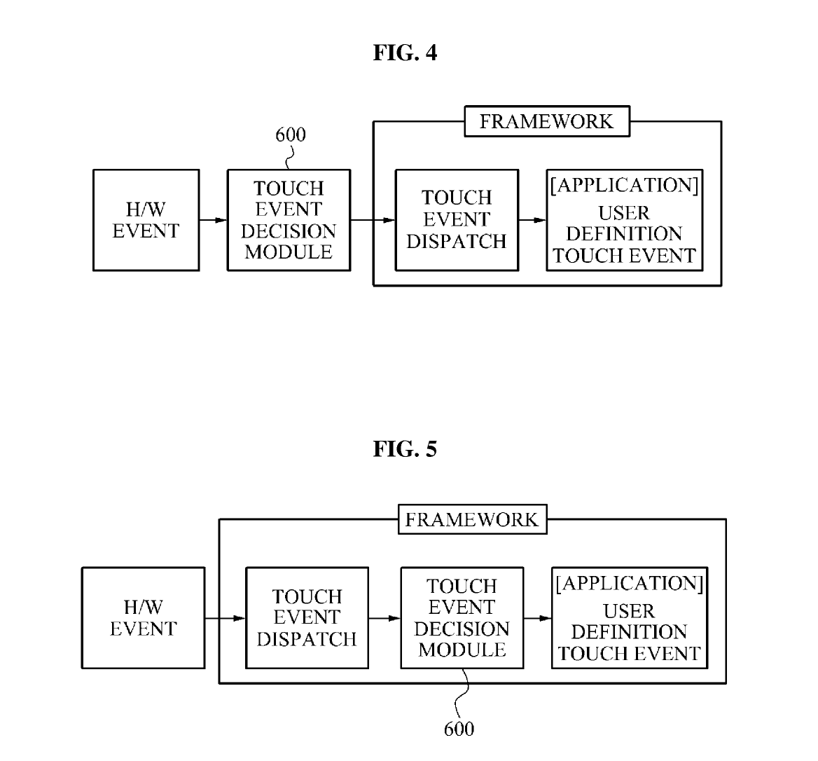

FIG. 4 and FIG. 5 are block diagrams illustrating processing of a touch event according to exemplary embodiments of the present invention.

A terminal according to exemplary embodiments of the present invention may include a touch event decision module 600 in a touch event flow of a terminal. The touch event decision module 600 may be classified as a hardware component in FIG. 4 and a software component in FIG. 5 based on an installation position. A hardware configuration may process some or all of the processes associated with determining a valid touch, may generate a corresponding touch event, and may determine whether to transmit the touch event. A software configuration may receive some or all of the touch events from the hardware components, may determine whether one or more of the received touch events are valid touches at a framework level, and then may determine whether to perform a corresponding action or operation.

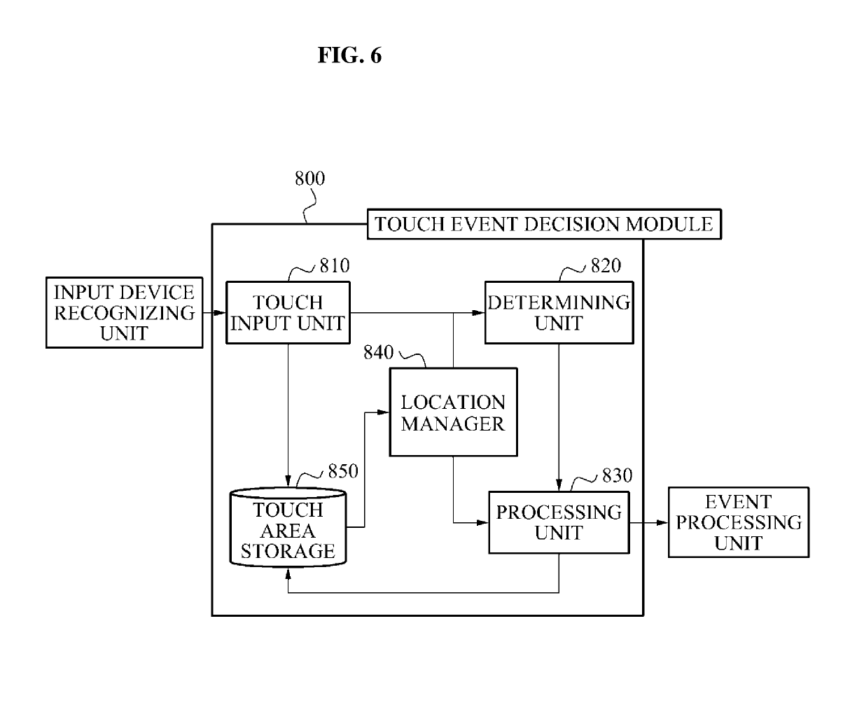

FIG. 6 is a block diagram illustrating a configuration of a touch event decision module 800 according to an exemplary embodiment of the present invention.

The touch event decision module 800 may operate to determine validity of a touch based on a location of a received touch. More specifically, the validity of the touch may be determined based on whether a touch is received from a grip recognition area or a display area. When the touch event decision module 800 determines that the received touch is a valid touch, a corresponding operation may be performed. Otherwise, information about the detected touch may be stored and then be discarded. Information about the detected touch may include, without limitation, at least one of a time of detection, a location of the touch, a size of the touch, a shape of the touch, and the like.

The touch event decision module 800 may include a touch input unit 810 to classify a touch detected on a display screen, a determining unit 820 to determine an intent or validity of the touch, a processing unit 830 to perform a corresponding event based on intent or validity of the touch, and a location manager 840 to set a relationship between the grip recognition area and the display area. Although the location manager 840 may set the relationship between the grip recognition area and the display area based on the received touch, aspects of the invention are not limited thereto, such that, the relationship between the grip recognition area and the display area may be predetermined or preconfigured in advance.

The touch input unit 810 may operate to extract information associated with a touch that is transferred from an input device recognizing unit. The touch input unit 810 may classify the transferred touch as a touch that is detected in the grip recognition area or a touch that is detected in the display area. However, aspects of the invention is not limited thereto, such that the touch input unit 810 may designate areas in addition to the grip recognition area or the display area.

The determining unit 820 may determine the validity of the transferred touch. The determining unit 820 may combine the transferred touch with an environment setting of the location manager 840 to determine whether the transferred touch is a touch associated with gripping or holding of a terminal or an intended touch on the terminal. However, aspects of the invention are not limited thereto, such that the determining unit 820 may combine the transferred touch with the environment setting of the location manager 840 to determine whether the transferred touch is an unintended touch (e.g., a user's palm accidentally covering the display area of the terminal).

The processing unit 830 may control a transfer of a touch value. The processing unit 830 may operate to transfer an event associated with the touch processed by the determining unit 820 to a subsequent operation. A valid touch value determined by the determining unit 820 may be transferred to the subsequent operation, whereas an invalid touch value may be stored in a touch area storage 850.

The location manager 840 operates to set a relationship between the grip recognition area and the display area, and to set a relationship that may associate the touch with the grip recognition area to determine validity of the touch. The location manager 840 may adjust the affect range of the grip recognition area based on an environment setting value. In an example, the environment setting value may correspond to, without limitation, at least one of a setting to lock the grip recognition area, a type of input that may expand an affect range of the grip recognition area into a part of the display area, and the like.

Further, the location manager 840 may adjust the overall size of the grip recognition area to be larger for users with bigger hands, which may correspondingly adjust the display area or the touch area to be smaller in response. Alternatively, the location manager 840 may adjust the overall size of the grip recognition area to be smaller for users with smaller hands, which may correspondingly adjust the display area or the touch area to be larger in response. Further, a user may manually adjust the size of the effective display area, the touch area, or the grip recognition area, and the grip recognition area may be adjusted independent of the display area. In an example, the touch area may be the same size as the display area, but is not limited thereto, such that the touch area may be larger or smaller than the display area.

The touch area storage 850 may store a value of a received touch. The touch area storage 850 may store values of the grip recognition area and/or other areas that may be determined to be unintentionally touched by the user. The stored values may be transferred to the location manager 840 and may be used as values by the location manager 840 to determine whether an intended user touch is detected.

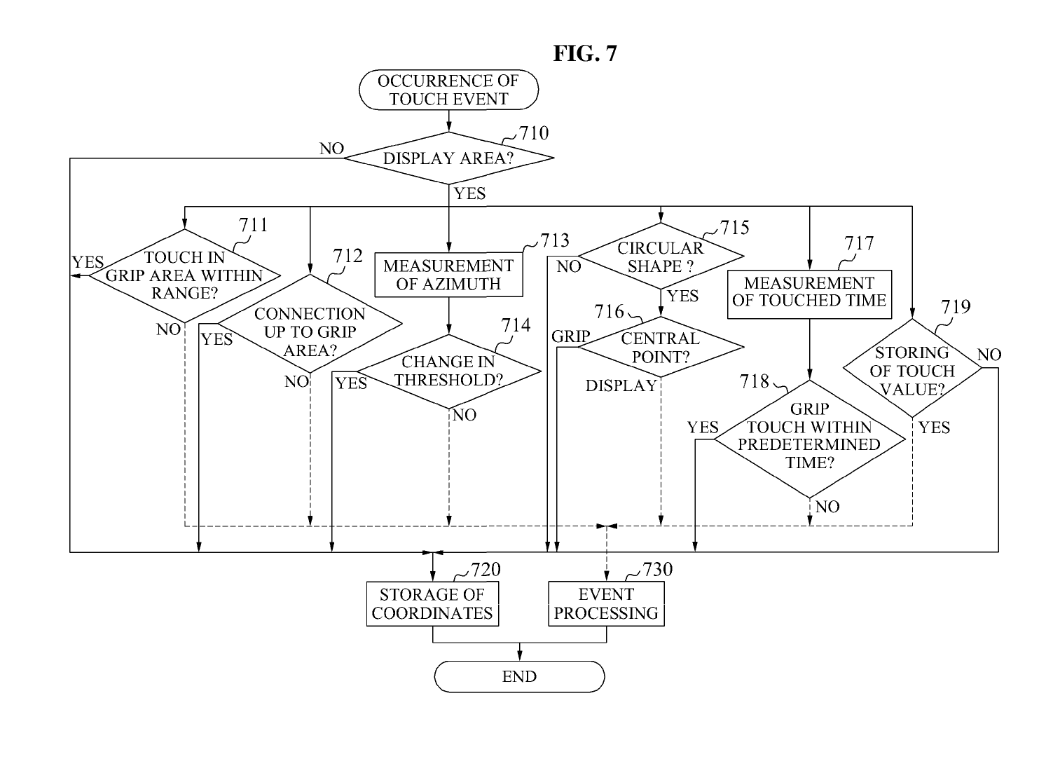

FIG. 7 is a flowchart illustrating a method for determining validity of a touch according to an exemplary embodiment of the present invention.

A method for processing a recognized touch will be described with reference to FIG. 7. Referring to FIG. 7, a method for determining validity of a touch may be incorporated to use at least six methods, however, aspects of the invention are not limited thereto. With respect to a touch that may be detected or received in an area determined to be a grip recognition area, a process may be terminated after storing a coordinate value of a corresponding area. FIG. 7 illustrates a case where a coordinate value may be stored in response to a determination that the received touch is in an area determined to be a grip recognition area, and a case where an event may be processed or executed in response to a determination by six illustrated methods that the received touch is in an area determined to be a display area. A more detailed description related to each method may be provided in reference to the provided figure. Although six categories of methods are separately provided for determining the validity of the touch based on the location of the touch, aspects of the invention are not limited thereto. For example, the six categories of methods may be combined or more, or fewer, than six categories of methods may be used in a determination of validity of the touch. For example, a terminal need not perform each of the categories or types of methods as illustrated in FIG. 7 such that a terminal may only perform one or two of such illustrated methods.

Referring to FIG. 7, in operation 710, a determination is made as to whether a touch event or a touch has occurred or detected on a display area of a terminal. If it is determined that the touch is not detected in the display area, the terminal stores coordinate corresponding to the detected touch.

Although it is not illustrated, if it is determined that the touch is detected in the display area, a determination of which of the six methods to apply may be made. However, aspects need not be limited thereto such that each of the methods may be executed or performed simultaneously or sequential, and such execution or performance of the methods may be selectable by a user or determined at a time of manufacture, generation, or origination.

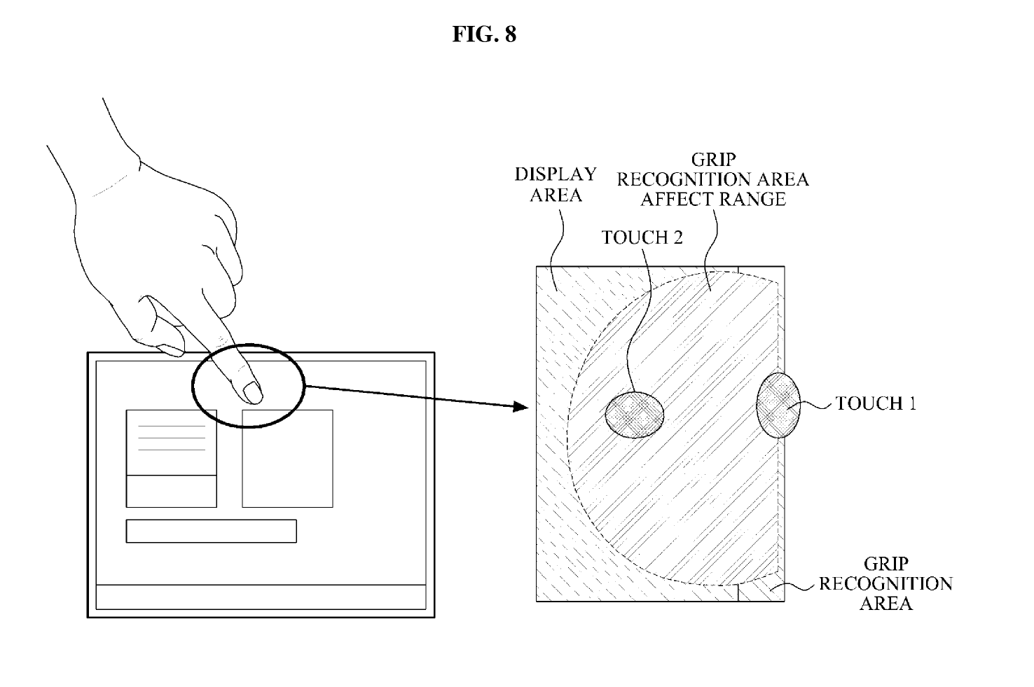

In operation 711, if the terminal determines that the detected touch is within a grip recognition area affect range, the terminal may determine that the detected touch in the display area is invalid and the terminal stores coordinates corresponding to the detected touch in operation 720. If the terminal determines that the detected touch is not within the grip recognition area affect range, the terminal processes an event corresponding to the touch in operation 730. In an example, the grip recognition area affect range may include an area of the display area that may be associated with a touch detected in the grip recognition area. A more detailed description of the grip recognition area affect range is provided in the description of FIG. 8 below.

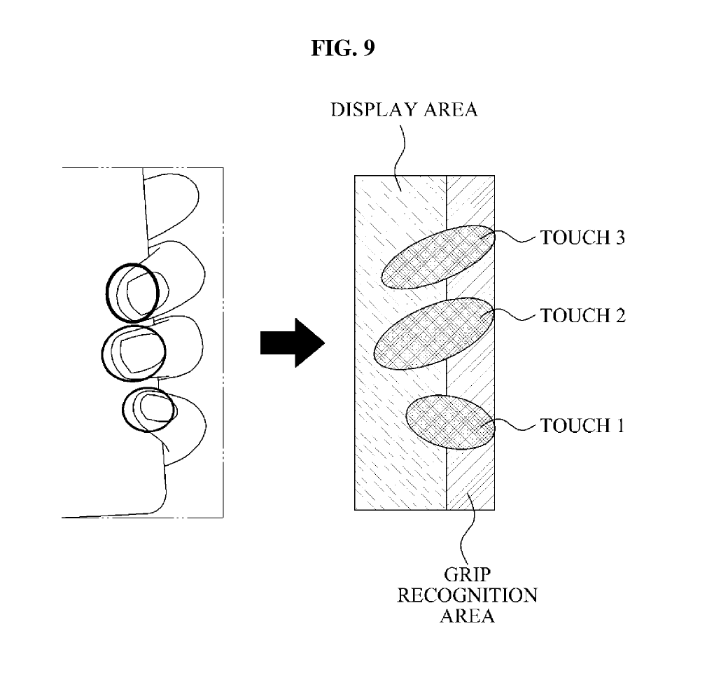

In operation 712, if the terminal determines that the detected touch is connected to a touch detected in the grip recognition area, the terminal may determine that the detected touch in the display area is invalid and the terminal stores coordinates corresponding to the detected touch in operation 720. If the terminal determines that the detected touch is not related or connected to the touch detected in the grip recognition area, the terminal processes an event corresponding to the touch in operation 730. A more detailed description of a touch connected to the grip recognition area is provided in the description of FIG. 9 below.

In operation 713, if the terminal determines that there is a change in an azimuth, the azimuth is measured to determine whether the change in the azimuth is at or beyond a reference threshold. In operation 714, if the change in azimuth is determined to be at or beyond the reference threshold, the terminal may determine that the detected touch in the display area is invalid and the terminal stores coordinates corresponding to the detected touch in operation 720. If the change in the azimuth is determine to be below the reference threshold, the terminal processes an event corresponding to the touch in operation 730.

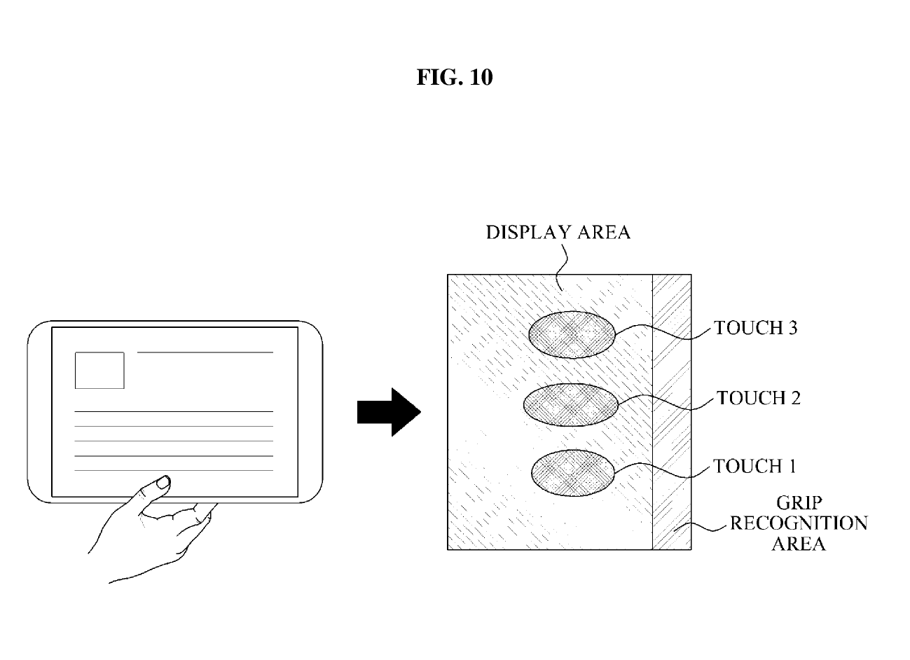

Although not illustrated, the azimuth may further be measured with respect to time. For example, when a value of the azimuth changes is at or above a reference threshold within a predetermined period of time after detecting the touch, the terminal may determine that the detected touch in the display area is invalid and the terminal stores coordinates corresponding to the detected touch. Accordingly, if the value of the azimuth change is above the reference threshold within the predetermined period of time, the terminal may determine that the detected touch in the display area is invalid and the terminal stores coordinates corresponding to the detected touch. If the value of the azimuth change is beyond the predetermined period of time or the value of the azimuth change is below the reference threshold, the terminal processes an event corresponding to the touch. A more detailed description of a change in azimuth is provided in the description of FIG. 10 below.

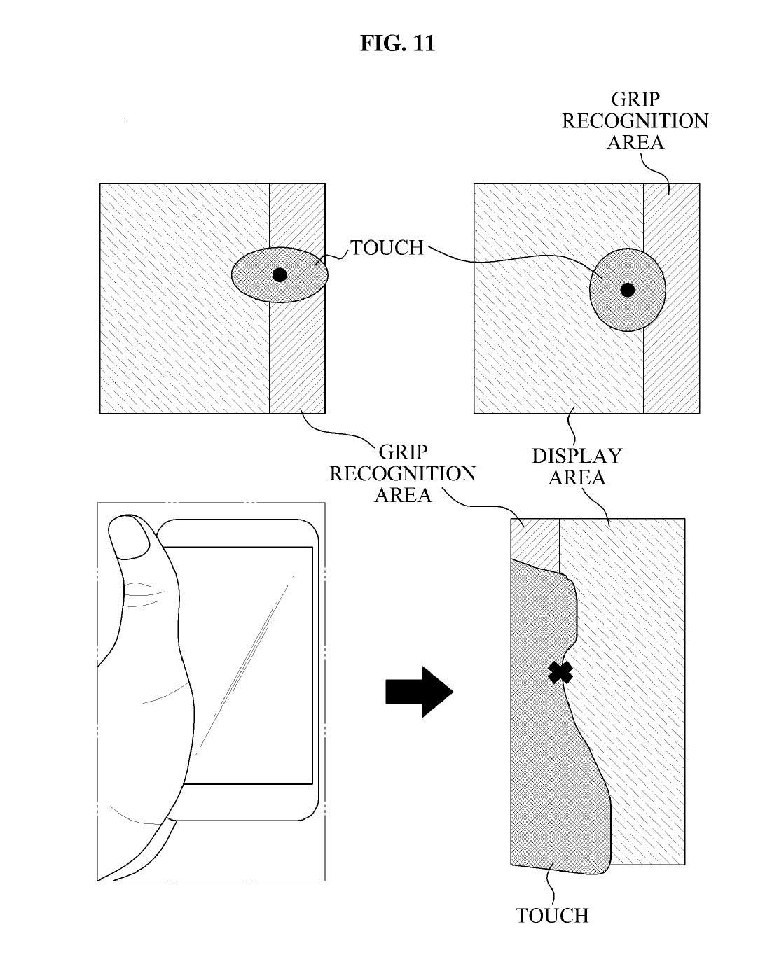

In operation 715, if the terminal determines that the detected touch does not correspond to a circular shape or other acceptable shape, the terminal may determine that the detected touch in the display area is invalid and the terminal stores coordinates corresponding to the detected touch in operation 720. If the terminal determines that the detected touch does have a circular or other acceptable shape, the terminal may determine whether the central point or region of the touch is located in the grip recognition area or the display area in operation 716. If the central point is determined to be located in the grip recognition area, the terminal may determine that the detected touch in the display area is invalid and the terminal stores coordinates corresponding to the detected touch in operation 720. If the central point is determined to be located in the display area, the terminal processes an event corresponding to the touch in operation 730. A more detailed description of a shape of the touch and location of the central point or region of the touch is provided in the description of FIG. 11 below.

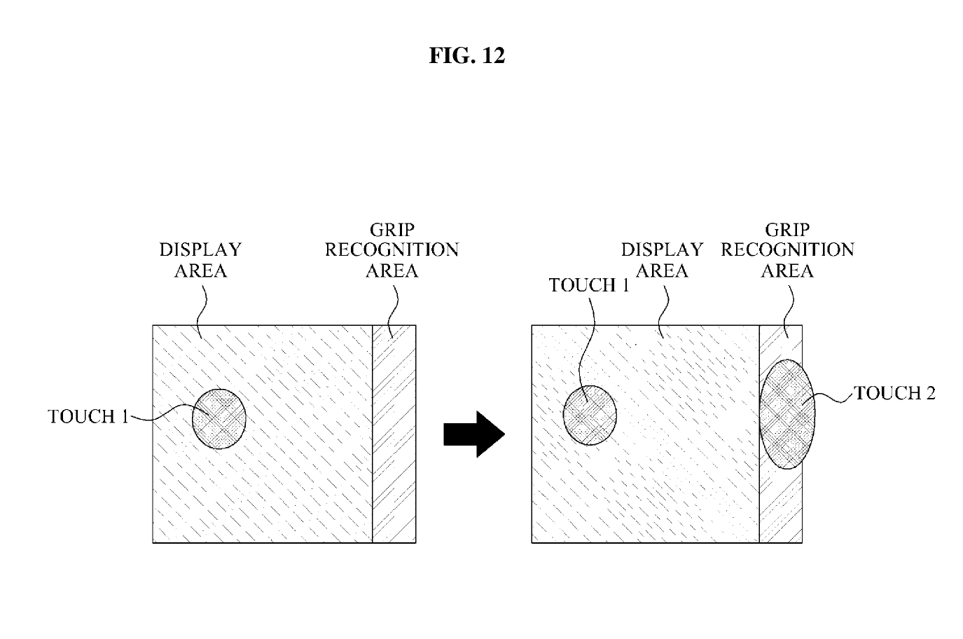

In operation 717 the terminal measures a period of time after a first touch is detected in the grip recognition area. In operation 718, if the terminal determines that a second touch in the display area is touched within a predetermined period of time after the first touch is detected in the grip recognition area, the terminal may determine that the detected second touch in the display area is invalid and the terminal stores coordinates corresponding to the detected second touch in operation 720. If the terminal determines that the detected second touch in the display area is detected after expiration of the predetermined period of time after the first touch is detected in the grip recognition area, the terminal process an event corresponding to the detected second touch in operation 730. A more detailed description of a touch connected to the grip recognition area is provided in the description of FIG. 12 below.

In operation 719, if the terminal determines that the detected touch is associated with storing of information associated with the detected touch or a touch value, the terminal may determine that the detected touch in the display area is invalid and the terminal stores coordinates corresponding to the detected touch. If the terminal determines that the detected touch in the display area is not associated with the storing of information associated with the detected touch or a touch value, the terminal processes an event corresponding to the touch.

FIG. 8 illustrates a method for extracting a touch detected within an affect range of a grip recognition area according to an exemplary embodiment of the present invention.

When a first touch is detected in the grip recognition area, a terminal may find a second touch may be detected within the affect range of the grip recognition area associated with the detected first touch, associate the second touch with the first touch, and may determine that the detected second touch is invalid. The affect range may refer to a predetermined distance, area, circumference, and the like. When a user touches the terminal as shown in a left image of FIG. 8, the touch may be recognized as shown in a right image of FIG. 8. Here, a second touch or a touch 2 detected in a display area may be a touch that may be received within the affect range of the grip recognition area associated with a first touch or touch 1 that is detected in the grip recognition area. Further, when the first touch and the second touch occur at the nearly same point in time or within a predetermined period of time, the second touch or touch 2 may be determined to be a touch associated with a gripping or holding of the terminal and thus, be stored in a touch area. The first touch and the second touch, or touch 1 and touch 2, may be determined to be invalid and thus, an event corresponding thereto may not occur.

Although not illustrated, if the second touch or touch 2 is determined not to be within the affect range of the grip recognition area associated with the first touch or touch 1, the detected second touch may correspond to an event. However, aspects of the invention are not limited thereto, such that the grip recognition area affect range may be stored in the touch area storage 850 for future use. Accordingly, if a second touch is independently detected at a part of the display area that is within the stored grip recognition area affect range, the second touch, without regard to the first touch, may be determined to be associated with a gripping or holding of the terminal. Further, the location manager 840 may adjust the effective touch area to account for the grip recognition area affect range. For example, the location manager 840 may adjust the effective display area to be smaller so that the grip recognition area affect range is included within the grip recognition area.

FIG. 9 illustrates a method for extracting a consecutively occurring touch detected in a grip recognition area and invalidating the extracted touch according to an exemplary embodiment of the present invention.

The above method may also be applied to a detected touch that extends beyond the grip recognition area. Unless a first touch or touch 1 is disconnected midway, a terminal may store an area or coordinates of the first touch and then invalidate the first touch. When the first touch is invalidated, coordinates of the first touch may be stored and the detected first touch may be deleted. More specifically, since a part of the first touch or touch 1 is detected at the grip recognition area and a remaining part of the same touch is detected in the display area, the first touch may be associated with the grip recognition area. Accordingly, the first touch may not generate a corresponding event. Further, the terminal may extract and invalidate a second touch or touch 2, and a third touch or touch 3 that may consecutively be detected in the grip recognition area. More specifically, when the terminal determines that the second touch and the third touch are detected within an affect range of the grip recognition area and/or within a predetermined period of time after the first touch is detected, the terminal may determine that the second touch and the third touch are related to the first touch. The terminal may determine that the first touch detected in the grip recognition area as an invalid touch and invalidate a corresponding touch event from occurring. Further, the terminal may determine that the second touch and the third touch are associated with the first touch and determine that the second touch and the third touch are invalid touches.

FIG. 10 illustrates a method for determining validity of a touch based on an azimuth measured from a gyro sensor according to an exemplary embodiment of the present invention.

In the case of a terminal that is calmly placed, a change may not occur in an azimuth. When a value of the azimuth changes beyond a reference threshold within a predetermined period of time after a touch is detected, the terminal may associate the detected touch as gripping or holding of the terminal and invalidate the recognized touch. When a user picks up the terminal that is placed on the floor as shown in a left image of FIG. 10, a second touch may detected to be slanted or more elliptical in shape compared to a first touch. In this case, the terminal may be determined to have been picked up from one direction and the azimuth may correspondingly be changed. When a time difference between a point in time when the first touch is detected and a point in time when the second touch is detected is less than a reference threshold, the terminal may determine that the first touch and the second touch are invalid. Accordingly, the terminal may store the first touch and the second touch that are detected on a display area and invalidate the first touch and the second touch.

FIG. 11 illustrates a circular detection method for determining validity of a touch based on a shape of the touch according to an exemplary embodiment of the present invention.

With respect to a touch including a grip recognition area, a terminal may verify or determine whether it is possible to generate a circular shape based on a recognized area. When a user holds or grips a terminal as shown in a bottom left image of FIG. 11, a touch may be recognized as a non-circular shape in an area as shown at a bottom right image of FIG. 11. In this case, the circular shape cannot be obtained and thus, the touch may be determined as an invalid touch, which may be deleted. However, aspects of the invention are not limited thereto, such that if a detected touch is recognized as a non-geometrical shape, or a shape that does not correspond to a touch made by a user's finger tips, the detected touch may be determined as an invalid touch.

On the other hand, as shown in top left and top right images of FIG. 11, a touch may be expressed in a circular shape. In this case, the terminal may obtain a central point of the touch corresponding to the circular shape. When the central point is determined to be positioned within the grip recognition area as shown in the top left image of FIG. 11, the terminal may determine that the touch is invalid and delete the touch. When the central point is determined to be positioned within the display area, the terminal may determine that the touch is valid and thereby execute a corresponding event.

FIG. 12 illustrates a method for considering a point in time when a touch occurs in a display area and when a touch occurs in a grip recognition area according to an exemplary embodiment of the present invention.

When a second touch or touch 2 is detected in the grip recognition area within a predetermined time after a first touch or touch 1 is detected in the display area, a terminal may analyze corresponding relationship between the two touches. As shown in FIG. 12, when the second touch is detected within the predetermined period of time after the first touch is detected, the terminal may determine whether the first touch has occurred within the affect range of the second touch. When the first touch is determined to be detected within the affect range of the second touch, the terminal may determine that both of the first touch and the second touch are is invalid and thereby, delete the first touch and the second touch. However, when the first touch is determined to be detected outside of the affect range of the second touch, the terminal may determine that the first touch is valid and execute a corresponding event.

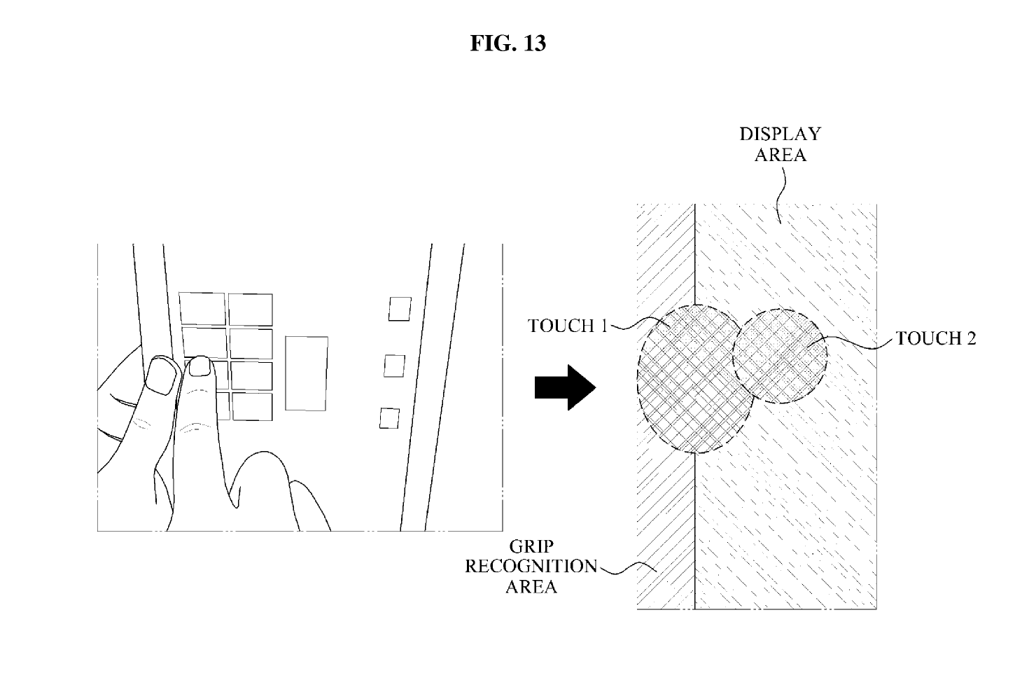

FIG. 13 illustrates a method for determining validity of a first touch by detecting whether a second touch has been received after the first touch is determined to be a touch by grip according to an exemplary embodiment of the present invention.

When a user touches a gripping area while inputting a touch in the display area as shown in a left image of FIG. 13, double touches may be detected as shown in a right image of FIG. 13. A double touch may refer to a touch sharing an overlapping area, but is not limited thereto. Further, aspects of the invention are not limited to double touches, such that multiple touches may be accommodated as well. Information associated with the first touch may be stored in a touch area storage of a touch event decision module. The information associated with the first touch may include at least one of a time of the first touch, coordinates of the first touch, a shape of the first touch, and the like. Therefore, when there is a time difference between a time of storage of information associated with the first touch and a time of detection of the second touch, the terminal may determine validity of the touch using at least one of a method for extracting a touch that is detected within a predetermined distance from the grip recognition area of FIG. 8, a method for extracting a touch in an area connected to the grip recognition area of FIG. 9, a method for detecting a shape of a touch of FIG. 11, and the like. For example, the terminal may determine a period of time that is elapsed between the detection of the first touch and the detection of the second touch, and may determine that the first touch and the second touch are invalid when the determined period of time is less than or equal to a predetermined value. On the contrary, when the determined period of time exceeds the predetermined value, the terminal may determine that the second touch is valid.

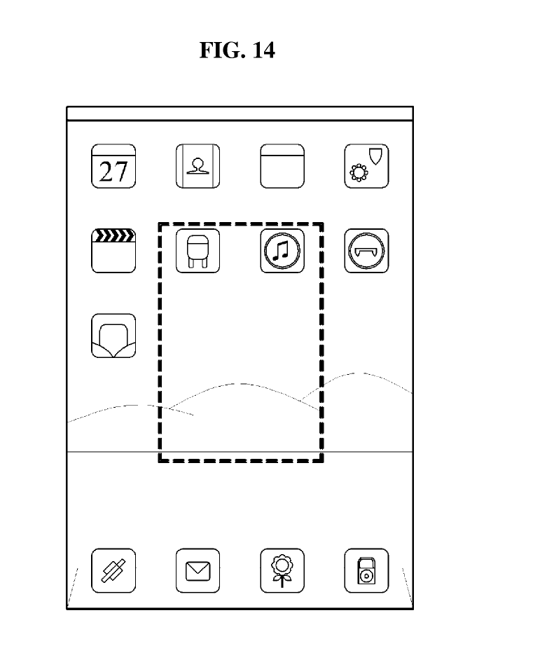

FIG. 14 is a view illustrating a method for setting a grip recognition area that affects a display area according to an exemplary embodiment of the present invention.

A terminal may set relationship between the grip recognition area and the display area. Further, the terminal may set a relationship that may be used to associate a display touch with the grip recognition area to determine validity of a detected touch. The terminal may adjust the affect range of the grip recognition area based on an environment setting value.

In an example, the grip recognition area may be used to provide control mechanisms, similar to a physical button disposed on the side of an existing terminal. For example, when touch and drag motion of a predetermined length is detected on the grip recognition area of the terminal, it may be possible to adjust a volume of sound or perform a scrolling operation on a browser. However, aspects of the invention are not limited thereto, such that a zooming control, camera control, directional control and the like may be implemented on s the grip recognition area.

Also, when adjusting a display area and a corresponding grip recognition area that may be set by a location manager, it may be possible to control a terminal without using a direct touch on a screen.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media, such as hard disks, floppy disks, and magnetic tape; optical media, such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, it may be possible to reduce a likelihood of performing a touch operation unintended by a user by providing a criterion to recognize a touch detected on a thin-bezel terminal that can be associated with gripping or holding of a terminal.

Accordingly, to reduce a likelihood of receiving an unintended touch on the thin- bezel terminal, a touch area of a display screen may be extended to cover a larger area of the display screen. When a touch occurs due to a user grip, a user may typically grip or hold an end portion of a terminal and/or a side portion of the terminal. In this case, the terminal may recognize a touch in such area and may classify the touch as an unintended user touch, which may be invalidated. Further, the terminal may also recognize other unintended touches, which may also be invalidated. Accordingly, it may be possible to reduce a likelihood of an unintended operation by performing an action corresponding to the validated touch.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a touch input unit to determine whether a first touch is detected in a display area or a grip recognition area;
a determining unit to determine validity of the first touch based on a location of the detected first touch; and
a processing unit to perform an event corresponding to the first touch when the first touch is determined to be valid.

2. The terminal of claim 1, wherein the first touch is determined to be valid if the first touch is detected in the display area and outside of an affect range of the grip recognition area.

3. The terminal of claim 1, wherein the first touch is determined to be invalid if the first touch is detected in the grip recognition area or within an affect range of the grip recognition area.

4. The terminal of claim 1, further comprising a location manager to adjust an affect area of the grip recognition area with respect to the display area.

5. The terminal of claim 4, further comprising a touch area storage to store information associated with the first touch when the first touch is determined to be invalid.

6. The terminal of claim 5, wherein the information associated with the first touch comprises at least one of a location of the first touch, a time of the first touch, a size of the first touch, and a shape of the first touch.

7. The terminal of claim 5, wherein the location manager adjusts the affect area of the grip recognition area based on the information stored in the touch area storage.

8. The terminal of claim 4, wherein the location manager expands a portion of the affect area of the grip recognition area into the display area when a second touch is detected in the display area within a predetermined period of time after the first touch is detected in the grip recognition area.

9. The terminal of claim 1, wherein the determining unit determines the first touch to be valid when a central point of the first touch is determined to be in the display area and outside of an affect range of the grip recognition area.

10. The terminal of claim 1, wherein the determining unit determines the first touch to be invalid when an azimuth of the terminal changes beyond a reference threshold within a predetermined period of time.

11. The terminal of claim 1, wherein the touch input unit determines a shape of the first touch, and when the shape of the first touch is determined to correspond to a predetermined shape the first touch is determined to be valid.

12. A method for validating a first touch using a processor, comprising:
detecting the first touch on a display area or a grip recognition area of a terminal;
determining validity of the first touch based on a location of the detected first touch; and
performing, using the processor, an event corresponding to the first touch if the first touch is determined to be valid.

13. The method of 12, wherein the first touch is determined to be valid if the first touch is detected in the display area and outside of an affect range of the grip recognition area.

14. The method of 12, wherein the first touch is determined to be invalid if the first touch is detected in the grip recognition area or within an affect range of the grip recognition area.

15. The method of 12, wherein an affect range of the grip recognition area expands into a portion of the display area when a second touch is detected in the display area within a predetermined period of time after the first touch is detected in the grip recognition area.

16. The method of 12, wherein the first touch is determined to be valid when a central point of the first touch is determined to be in the display area and outside of an affect range of the grip recognition area.

17. The method of 12, wherein the first touch is determined to be invalid if an azimuth of the terminal changes beyond a reference threshold within a predetermined period of time.

18. The method of 12, further comprising determining a shape of the first touch, wherein when the shape of the first touch is determined to correspond to a predetermined shape and detected in the display area, the first touch is determined to be valid.

19. The method of 12, wherein a second touch in the grip recognition area controls an operation of the terminal.

20. A non-transitory computer-readable medium comprising a program, executable by a computer, to perform a method for validating a touch using a processor, the method comprising:
detecting the touch on a display area or a grip recognition area of a terminal;
determining validity of the touch based on a location of the detected touch; and performing, using the processor, an event corresponding to the touch when the touch is determined to be valid.
